(19) United States
(12) Patent Application Publication
(10) Pub. No.: US 2011/0165783 A1
(43) Pub. Date: Jul. 7, 2011

(54) Dual Card Connector

(76) Inventors: Mark S Tracy, Houston, TX (US); Earl W. Moore, Cypress, TX (US)

(21) Appl. No.: 13/062,966

(22) PCT Filed: Sep. 30, 2008
(86) PCT No.: PCT/US08/78278

§ 371 Date: Mar. 9, 2011

(51) Int. Cl. H01R 12/73

(52) U.S. Cl. 439/61

(57) ABSTRACT

A dual card connector assembly electrically connects two cards to a system board. The connector assembly includes an insulating housing and an electrical contact area for electrically coupling the connector to a system board. The insulating housing includes a first elongated slot disposed on a front side of the connector and adapted to receive a connection end of a first card, the first elongated slot including a plurality of electrical contacts for mating with corresponding contacts on the first card, and a second elongated slot disposed on a back side of the connector and adapted to receive a connection end of a second i card, the second elongated slot including a plurality of electrical contacts for mating with corresponding contacts on the second card.

### BACKGROUND

Wireless communication cards typically are called mini cards (PCI and PCI Express) in the notebook PC world. PCI Express mini cards have a “footprint” of 30×56 mm, meaning they occupy an area defined by these dimensions on a system board (i.e., a printed circuit board (PCB)). New generation mini cards are approximately one half the size of traditional mini cards, and thus are called mini half cards. For example, typical full length LAN mini cards are being replaced with half card configurations while new UWB (Ultra Wide Band, Bluetooth replacements) will be established in the half size mini card format. These mini half cards are attached to a system board , typically by soldering or screws. Signal connection to the system board typically is by way of a 52-pin connector.

### SUMMARY

What is disclosed is a dual card connector assembly for electrically connecting two cards to a system board. The connector assembly includes an insulating housing and an electrical contact area for electrically coupling the connector to a system board. The insulating housing includes a first elongated slot disposed on a front side of the connector and adapted to receive a connection end of a first card, the first elongated slot including a plurality of electrical contacts for mating with corresponding contacts on the first card, and a second elongated slot disposed on a back side of the connector and adapted to receive a connection end of a second card, the second elongated slot including a plurality of electrical contacts for mating with corresponding contacts on the second card.

### DESCRIPTION OF THE DRAWINGS

The detailed description will refer to the following drawings in which like numerals refer to like items, and in which:

FIG. 1 illustrates a typical mini half card that may be used for various wireless communications applications;

FIG. 2 illustrates a current 52-pin connector for signal connection of the mini half card of FIG. 1 to an associated system board;

FIGS. 3A and 3B illustrate one arrangement of mini half card connectors in current applications;

FIGS. 4A and 4B illustrate an embodiment of an improved card connector for signal connection of cards to a system board; and

FIG. 5 illustrates an application of the card connector of FIGS. 4A and 4B.

### DETAILED DESCRIPTION

Wireless communication cards are typically called mini cards (PCI, PCI Express) in the notebook PC world. Full length PCI mini cards are about 30 mm×56 mm in area, and about 5 mm in thickness. Each full length PCI mini card includes a 52 pin edge connector, consisting of two staggered rows on a 0.8 mm pitch (i.e., one row on the top side of the card, and one row on the bottom side of the card. Each row has 8 contacts, a gap, or groove, equivalent to 4 contacts (for alignment purposes), then a further 18 contacts. A new generation PCI mini card is approximately one half the length of traditional mini cards, and thus is called a mini half card. A mini half card is specified at about 30×31.9 mm, and with the same thickness of a fill size mini card, namely 5 mm. These new mini half cards are being used in PC and sub-PC applications including as LAN cards and for UWB (Ultra Wide Band) and Bluetooth applications. These mini half cards retain the same 52 pin connector for signal connection to an associated system board.

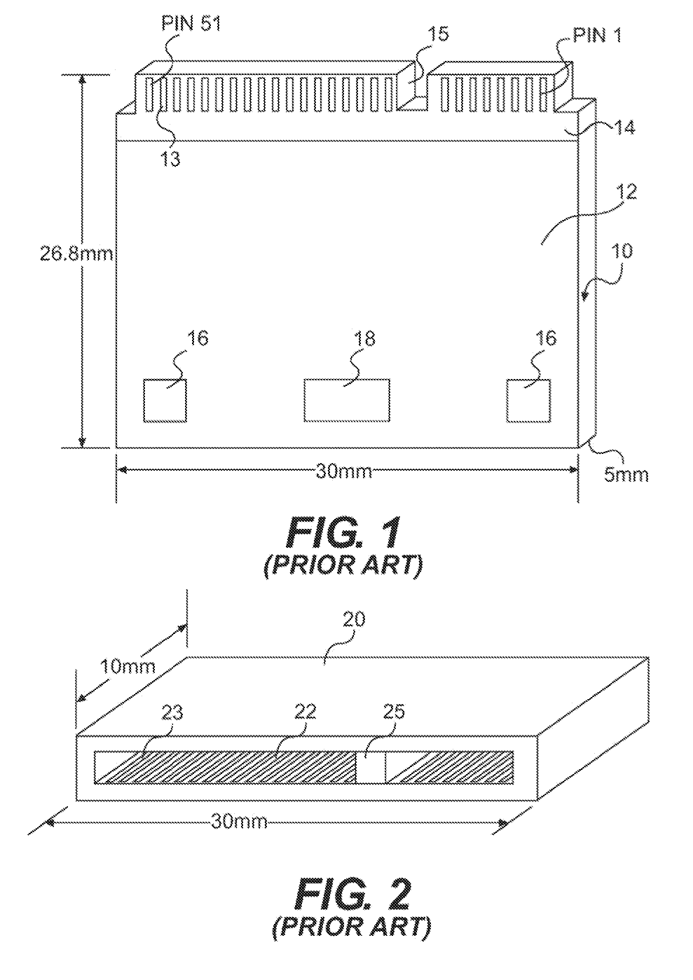

FIG. 1 illustrates a typical current mini half card that may be used for various wireless communications applications. In FIG. 1, mini half card 10 (with approximate dimensions as shown) includes main area 12 for component installation, connection area 14 to accommodate a 52-pin connector (see FIG. 2), hold down areas 16, and I/O area 18. The connection area 14 includes 52 pins 13 in a staggered arrangement on the top and bottom sides of the connection area, and a groove 15 to ensure proper alignment of the card 10 and the 52-pin connector. The hold down areas 16 are used to mechanically connect the mini half card 10 to a system board (not shown), and may include screw connections, or solder posts, for example. The I/O area 18 may be used to provide cabled access between the card 10 and media interfaces such as LAN and modem line interfaces and RF antennas. If not needed for I/O connectivity, the I/O area may be used for other circuitry.

FIG. 2 illustrates a current 52-pin connector 20 for signal connection of the mini half card 10 of FIG. 1 to an associated system board. The connector 20 has the dimensions shown, and generally consists of an open area 22 into which the connection area 14 of the mini half card 10 is fitted. The open area 22 includes 52 individual pins, or connectors, 23 to match the 52 pins of the card 10, as well as an alignment pin 25 that mates with the alignment groove 15 (see FIG. 1). The connector 20 is attached to the system board, typically by soldering to leads on the system board.

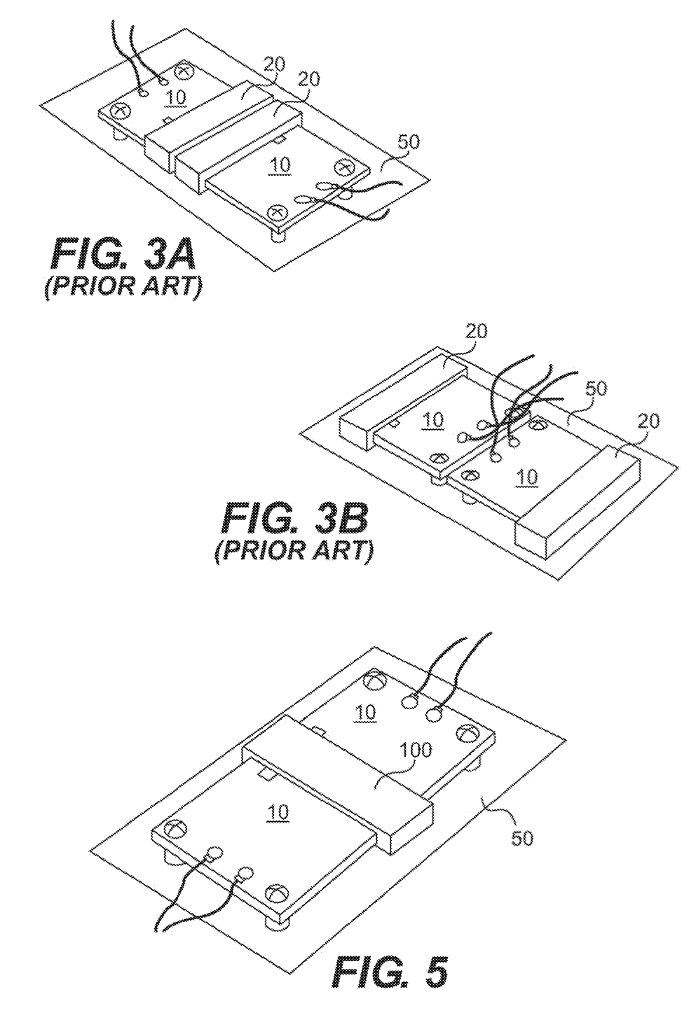

FIGS. 3A and 3B illustrate current attachment options for connecting a mini half card to a system board. In FIG. 3A, two mini half cards 10, and corresponding connectors 20, are placed on system board 50 in a back-to-back (connector-to-connector) arrangement. The footprint, or area of the system board occupied by this arrangement of the two mini half cards 10 is larger than the footprint for a single full mini card. The arrangement shown in FIG. 3A has the advantage of separating the I/O areas 18 of the cards 10 from each other.

FIG. 3B illustrates an alternate arrangement of two mini half cards 10 on the system board 50. In this arrangement, the footprint still exceeds that of a single full mini card. In addition, with the two I/O areas adjacent each other, RF interference may occur.

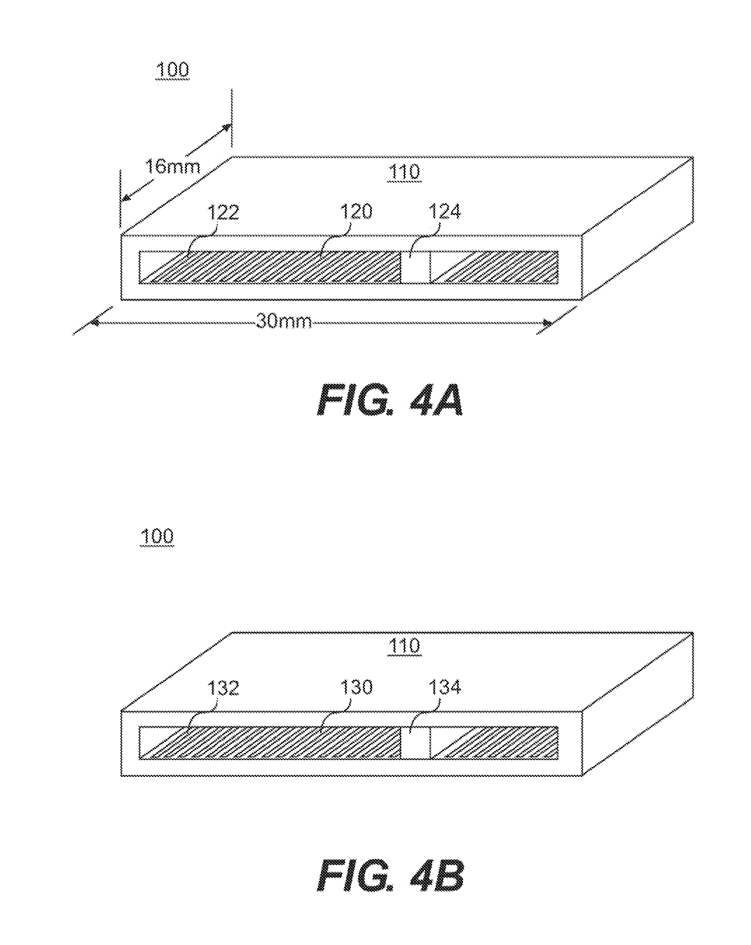

FIGS. 4A and 4B illustrate an embodiment of an improved dual card connector that is one piece and has connector contacts at both ends. This improved connector allows for a smaller system board footprint for two populated cards, such as two mini half cards, for example, which allows designs that take advantage of the smallest notebook PC form factor when dual mini half cards are a program requirement.

As shown in front view in FIG. 4A, dual card connector 100 includes insulating housing 110 having an elongated connection slot 120 for receiving the 52-pin connection area 18 of a card, such as a mini half card 10 (see FIG. 1) and for connection of the connector 100 to a system board, such as a printed circuit board. The insulating housing 110 may be molded from an insulating material such as plastic. FIG. 4B shows the connector 100 in rear view, with elongated connection slot 130 for receiving the 52-pin connection area of another card. Each slot 120/130 includes a plurality of contacts 122/132 for electrical connection to the electrical contacts of the mini half card 10. Each slot 120 and 130 optionally includes respective key 124/134 for alignment of the mini half card 10 and the connector 100. The dual card connector 100 is attached to and passes signals to system board 50 through an electrical contact area (not shown) employing, for example, a solder assembly comprising soldered signal pins.

The dimensions of the dual card connector 100 are those shown in FIG. 4A. In an embodiment, because the dual card connector 100 is used to couple two mini half cards 10 to the system board 50, the footprint of the mini half cards 10 and the dual card connector 100 is less than that of conventional mini half cards with their separate connectors, and also is less than the footprint for a full mini card, or other card, and its connector. That is, the insulating housing 110 has a footprint that is less than twice the footprint of a single mini half card insulating housing. In an alternate embodiment, the footprint of the insulating housing used with the dual card connector 100 may be equal to that of two single connector insulating housings, or may be larger. When the dimensions of the housing 110 are those shown in FIG. 4A, this reduced footprint provides a savings in space on a PC system board, which in turn allows a smaller PC form factor compared to traditional designs, and a reduction in weight from that of two separate mini half card connectors. In addition, the configuration of the dual mini half cards and connector allows the antenna cable connection to be at opposing ends to enhance wireless performance.

Other advantages to the connector 100 include:

One piece connector as opposed to two separate connectors,

Simpler mechanical cable routing with the opposing antenna cables,

PCB assembly optimized with placing one connector instead of two, and

The user access door can be smaller in size, which improves mechanical integrity of the base enclosure.

FIG. 5 illustrates a representative arrangement of the dual card connector of FIGS. 4A and 4B, and two mini half cards. As can be seen, the connector 100 is used to electrically connect two mini half cards 10 to system board 50. The resulting assembly achieves a footprint less than that of the arrangements shown in FIGS. 3A and 3B, and maintains the cable connections (I/O areas) away from each other and away from the insulating housing 110, thereby maintaining desired RF performance.

The above disclosed dual card connector may be adapted to receive electrical components other than mini half cards, including, for example, two full mini cards. Furthermore, the attached cards may be used for purposes other than wireless connectivity, as those skilled in the art will appreciate. In addition, changes may be made to the details of the structure and function of the dual card connector, especially in matters of size, shape, materials of construction, and arrangement of components, while remaining within the spirit and intent of the inventions as recited in the claims that follow.

1. A dual card connector assembly for electrically connecting two cards to a system board, comprising:
an insulating housing, comprising:
a first elongated slot disposed on a front side of the connector and adapted to receive a connection end of a first card, the first elongated slot including a plurality of electrical contacts for mating with corresponding contacts on the first card, and
a second elongated slot disposed on a back side of the connector and adapted to receive a connection end of a second card, the second elongated slot including a plurality of electrical contacts for mating with corresponding contacts on the second card; and
an electrical contact area for electrically coupling the connector to the system board.

2. The connector assembly of claim 1, wherein the first and the second elongated slots each comprise 52 electrical contacts.

3. The connector assembly of claim 1, wherein the electrical contact area comprises a solder assembly for soldering the connector to the system board.

4. The connector assembly of claim 1, wherein the insulating housing comprises a footprint less than twice the footprint of a single card connector insulating housing.

5. The connector assembly of claim 1, wherein the first elongated slot further comprises a first alignment key disposed to fit into a corresponding groove in the connection end of the first card and the second elongated slot further comprises a second alignment key disposed to fit into a corresponding groove in the connection end of the second card;

6. The connector assembly of claim 1, wherein the first and the second cards each comprise mini half cards.

7. A card edge connector for electrically connecting two cards to a system board, the system board supporting electrical components, comprising:
a single insulating housing, comprising:
a first slot connection for electrical connection of a first card, and
a second slot connection for electrical connection of a second card; and
an electrical contact area disposed on the insulating housing, the electrical contact area forming an electrical connecting between the first and the second slot connections and the electrical components of the system board.

8. The card edge connector of claim 7, wherein the cards are mini half cards.

9. The card edge connector of claim 7, wherein the insulating housing has a footprint less than that of two single card edge connectors.
